(19) United States
(12) Patent Application Publication
(10) Pub. No.: US 2009/0005125 A2
(43) Pub. Date: Jan. 1, 2009

(54) HANDS-FREE INSTALLATION

(76) Inventors: Edgar Venhofen, Koeln (DE); Dietmar Jung, Bad Oeynhausen (DE)

Correspondence Address: RANKIN, HILL & CLARK LLP, 38210 Glenn Avenue, WILLOUGHBY, OH, 44094-7808, UNITED STATES, 216-566-9700, 216-566-9711, docketing@rankinhill.com

(21) Appl. No.: 12/026,880

(22) Filed: Feb. 6, 2008

(30) Foreign Application Priority Data
Feb. 6, 2007 (DE) 20 2007 001 708.1

(51) Int. Cl. H04M 1/00

(52) U.S. Cl. 455/569.2

(57) ABSTRACT

A hands-free installation for a mobile telephone comprises a housing and an electrical communication device, located in the housing, for communicating with the mobile telephone. In addition, the communication device has a microphone connected to it. According to the invention, the housing comprises a mounting apparatus for detachable connection to a steering-wheel ring on a motor vehicle steering wheel. This means that the hands-free installation allows good intelligibility to be achieved when telephoning without significantly increasing the risk of accident, and means that the hands-free installation can easily be integrated into a motor vehicle.

### BACKGROUND OF THE INVENTION

The invention relates to a hands-free installation for a mobile telephone which allows a car driver, for example, to use his mobile telephone for telephoning without taking his hands from the steering wheel of his motor vehicle.

Hands-free installations for mobile telephones are known which are mounted in the interior of a motor vehicle. Such hands-free installations are in some cases mounted at locations which are at a significant distance from the driver, which means that not least the distance and the background noise which arises when driving mean that intelligibility when telephoning is adversely affected. To improve intelligibility when telephoning, it is possible to mount the hands-free installation closer to the driver. However, the proximity of the hands-free installation causes the driver to be obstructed and/or to have his vision of the road impaired when operating the motor vehicle on account of the hands-free installation being in the way. Operational and visual obstacles arise particularly also as a result of flexible microphones and power supply cables connected to the hands-free installation. Hence, the operational and visual obstacles mean that the risk of accident is increased with such hands-free installations.

DE 20 2004 014 643 discloses a hands-free installation which is integrated in a rear view mirror in the motor vehicle. The microphone and the power supply cables for the hands-free installation are likewise integrated in the rear view mirror, with the power supply cables running through a mount for the rear view mirror into the roof of the motor vehicle and from there to a car battery.

In addition, DE 10 2004 007 253 B3 discloses the process of integrating a hands-free installation into a central region, arranged inside a steering-wheel ring, of a motor vehicle steering wheel. In this case, the hands-free installation is operated by means of keys which are embedded in the central region and/or in the steering-wheel ring. The supply of power and communication with the mobile telephone take place within the steering wheel in this context.

A drawback of a hands-free installation of this kind is that the geometry of the motor vehicle needs to be matched appreciably to the hands-free installation in order to allow the hands-free installation's functionality. This increases the complexity of development and design when planning the motor vehicle and thereby results in higher costs with simultaneously low flexibility for the functionality of the hands-free installation.

### SUMMARY OF THE INVENTION

It is an object of the invention to provide a hands-free installation for a mobile telephone which, without significantly increasing the risk of accident, allows good intelligibility when telephoning and can easily be integrated into a motor vehicle.

The hands-free installation according to the invention for a mobile telephone comprises a housing into which an electrical communication device for communicating with the mobile telephone is located. The communication device comprises a microphone connected to it, particularly inside the housing, which can also be used for voice-dialing a telephone number, for example. According to the invention, the housing comprises a mounting apparatus for detachable connection to a steering-wheel ring of a motor vehicle steering wheel.

Since the inventive hands-free installation can be mounted on the motor vehicle steering wheel as a whole using the specifically matched mounting apparatus, the hands-free installation is at a position which is particularly close to the driver's direction of speech. This assures good intelligibility when telephoning. In addition, the hands-free installation is at a position in which it does not obstruct the driver's vision, which means that there is no significant increase in the risk of accident. The likelihood of the hands-free installation disturbing the driver when steering, is, particularly if the hands-free installation is arranged on the inside of the steering ring, preferably at the highest point when driving straight on, extremely low. Since all elements of the hands-free installation are combined in a common component, the hands-free installation can easily be integrated into the motor vehicle without the need for special provisions to be made in the motor vehicle for integrating the hands-free installation. In addition, it is possible to ensure exclusively communication between the mobile telephone and the hands-free installation, so that it is not necessary to provide interposed communication components. This means that the hands-free installation and the mobile telephone can communicate independently of communication components provided in the motor vehicle, so that operation is possible even when the motor vehicle is switched off, and no interference and other interactions with the motor vehicle electronics can occur even when the motor vehicle is operating. Instead, the hands-free installation can quickly be fitted and/or removed when required using the mounting apparatus. This allows the hands-free installation to be used in several different motor vehicles, regardless of motor vehicle type.

Preferably, the housing and/or the mounting apparatus match the contour of the steering-wheel ring. By way of example, the housing, which contains the communication device and the microphone, is in arcuate form in line with the curvature of the steering-wheel ring so as to fit into the design of the steering wheel and to nestle against the steering-wheel ring with as small a gap as possible between the steering-wheel ring and the housing. Particularly in the mounted state, that is to say when the hands-free installation is connected to the steering-wheel ring by means of the mounting apparatus, the housing and/or the mounting apparatus can engage in finger depressions in the steering-wheel ring. Since the finger depressions are normally arranged over the entire circumference of the steering-wheel ring in order to allow the fingers of the driver's hand a defined hold and improved grip, the hands-free installation can be connected to the steering wheel in almost any desired relative position. The at least partial engagement of the components of the hands-free installation in the finger depressions improves the stability of the connection of the hands-free installation to the steering-wheel ring, since the hands-free installation is prevented from slipping in the circumferential direction.

Particularly preferably, the housing comprises operator-control elements for operating the hands-free installation, such as keys, toggle switches, touch-sensitive areas etc., which are arranged essentially on the side of the housing. Since the operator-control elements are arranged not on the front and the back, which extend essentially radially relative to the steering-wheel ring, but rather on the side faces connected to the front and the back between them, the space provided by the front and/or the back for other functional elements of the hands-free installation, such as a display or loudspeaker outlets, can be used. This allows the hands-free installation to be of particularly small and compact design. Particularly preferably, at least some of the operator control elements are arranged on that side of the housing which points radially inwards relative to the steering-wheel ring. In this case, the direction of force when operating the operator control elements points to that side of the steering-wheel ring which points radially inwards, so that a bending moment and/or torque which might result in the hands-free installation being twisted is prevented.

Preferably, the communication device is supplied with electrical power by an integrated power unit which can operate independently of other power sources. The power unit, which preferably comprise a battery, particularly a rechargeable battery (storage battery), means that the power supply for the hands-free installation is independent of an external power source, such as a car battery in a motor vehicle, and is therefore autonomous in terms of power. There is no need for a network of wires which has to be laid through the means of transportation up to the power source and whose laying requires the requisite installation space and an appropriate infrastructure to be provided in the bodywork of the means of transportation.

Preferably, the power unit and/or the communication device are arranged in a driver's direction of speech or viewing direction on the back of the housing, which does not unnecessarily restrict the driver's range of movement. In addition, this saves installation space in the front region and in a circumferential direction which can be used for a different purpose, for example by electronic additional devices connected detachably or undetachably to the housing. For example, a navigation system and/or a position finding system such as GPS may be integrated into the hands-free installation. Connecting an navigation system without the hands-free installation for mobile telephones via an adapted mounting apparatus as previously described to the steering-wheel ring of a motor vehicle steering wheel is an independent invention.

Preferably, the inventive hands-free installation and/or the storage battery has an electrical connection, for example a connection socket, which can be used to connect an external electrical power source. This means that it is possible, in principle, to operate the hands-free installation without the integrated power unit, for example just with a car battery connected via a cigarette lighter. Particularly preferably, however, the electrical connection is used to charge the storage battery. This can also be done during travel, e.g. using a connected car battery, or in the removed state, when the hands-free installation and/or the storage battery is connected to a conventional power supply system, for example.

Preferably, the communication between the hands-free installation's communication device and the mobile telephone takes place wirelessly, particularly by radio, such as by means of Bluetooth. This avoids irritating cables. Preferably, at least one loudspeaker connected to the communication device may be provided, the housing having particularly loudspeaker outputs pointing to the driver in the mounted state. This results in good acoustics and improves telephone comfort. The loudspeaker outputs may also be in the form of plug-in and detachable supplementary components. The loudspeaker connected to the communication device can output sounds, particularly speech, so that the driver can hear the other party to the call who is connected via the hands-free installation. In addition or as an alternative, provision may be made for the communication device to communicate with an external sound installation, which has a loudspeaker, preferably wirelessly, for example using the A2DP standard. In particular, the hands-free installation comprises an FM transmitter which can be used for transmitting on a frequency which can be received by the car radio. Preferably, the FM transmitter is in a form such that the radio frequency currently set on the car radio is detected, preferably wirelessly. This allows an existing infrastructure to be used in order to improve sound quality. By way of example, in the case of a telephone call, the received call from the other party on the telephone can be output via the loudspeaker of a car radio and/or a CD player. To this end, a telephone call is output by the communication unit in the form of an RF signal which can be received by the car radio, for example, and is received by the car radio as an FM radio signal on a particular, especially a predefined, frequency. Particularly if this simultaneously at least reduces the volume of the sounds from the car radio and/or from the CD player, background noise is reduced and telephone comfort is improved.

Preferably, a data port, e.g. a USB port, plug-in card port or the like, is provided which can be used to interchange data with the electronic units in the hands-free installation. This means that data from the communication device, such as incoming and outgoing telephone numbers, or from the navigation system, such as distance traveled, can be read. It is also possible to input data into the hands-free installation, for example in order to supply the navigation system with additional map material or to load a new piece of software for the communication device. By way of example, simple insertion of a small USB stick allows a piece of software specifically matching the mobile telephone used to be loaded, so that the hands-free installation can quickly be matched to different users with different mobile telephones without any installation complexity.

Preferably, the hands-free installation has a display integrated in the housing for electronically presenting information. By way of example, this allows the time, the date and similar general data to be displayed. Particularly preferably, the display displays data which are output by a possibly provided navigation system with a position finding system or which appear on the mobile telephone's display, such as the name and/or telephone number for an incoming call. Depending on the positioning of the hands-free installation relative to the steering-wheel ring, the presentation on the display can be rotated on a software basis. If the hands-free installation is mounted not at the geodetically highest point of the steering-wheel ring but rather at the opposite lowest point of the steering-wheel ring, the presentation in the display can be rotated through 180°. Particularly preferably, the hands-free installation automatically detects its position in relation to the direction of gravity, so that even when the steering wheel moves, the presentation in the display is always in the same orientation.

In particular, a signal coming from the hands-free installation can be used to obtain an address book for the mobile telephone in order to show a name on the display which is linked to an incoming telephone number by the address book obtained. This is done particularly by virtue of an AT Command signal emitted by the hands-free installation preferably automatically, for example when the hands-free installation is switched on, being used to trigger an OPP (Object Push Profile) command in the mobile telephone in order to copy an address book from the mobile telephone to the hands-free installation, so that an incoming telephone number can be linked to a name within the hands-free installation in order to present the corresponding name from the address book on the display in addition to or instead of the incoming telephone number. In particular, when the mobile telephone is connected to the hands-free installation, when the mobile telephone and the hands-free installation finish a first handshake with one another, the address book stored in the mobile telephone can be read and preferably stored in a memory unit in the hands-free installation. This is done particularly by the syncML protocol, so that data alignment is simplified. In particular, it is preferably optionally possible for the address book which has been read in to remain stored in the memory unit. This means that it is possible to synchronize the address book stored in the memory unit when next connecting to the mobile telephone and/or to perform an update. This also allows a rotary knob and/or a rotary wheel, for example, to be used to go through the individual stored data in order to select a telephone number to be dialed which is associated with a particular name. Preferably, at least one speed dial key is provided which can be assigned an individually defined telephone number in order to avoid relatively long searching for frequently used telephone numbers. Particularly if the mobile telephone has been lost temporarily, it is also possible to synchronize and/or update the mobile telephone's address book with the data stored in the memory unit. Particularly preferably, the memory unit can be used to store and manage a plurality of different address books from different mobile telephones. Preferably, a user can select whether information from his own mobile telephone's address book which has been read in can also be used for other mobile telephones communicating with the hands-free installation if not his own but rather another mobile telephone is communicating with the hands-free installation. If different names are stored for one and the same telephone number in different address books in this case, preferably the name of that address book which is associated with the currently communicating mobile telephone is used.

Preferably, a remote control is provided which can be used to operate the hands-free installation and/or the mobile telephone particularly wirelessly, for example by means of Bluetooth and/or infrared. This allows operation to be simplified according to the driving situation. In particular, an operator sitting in the rear area of a motor vehicle can also operate the hands-free installation, so that the driver does not need to take his hands from the wheel in order to use the hands-free device. In addition or as an alternative, the hands-free installation may be equipped with voice control in order to operate the hands-free installation using spoken commands without needing to take one's hands from the wheel.

The display is, in particular, a backlit full display whose colour is preferably adjustable. In particular, it can display at least 14 characters, that is to say letters, numbers, special characters, graphics etc., and a plurality of lines may also be provided for showing characters, said lines respectively being able to present the appropriate number of characters. By way of example, this allows SMS or photographs to be shown. In addition or as an alternative, the display may be able to be folded back. It is therefore possible to conceal the display below a lid at first, for example to protect against soiling or damage, and to uncover it only when needed. In addition, the lid may contain additional operator control elements in order to provide a keyboard containing the letters of the alphabet, for example.

By way of example, the mounting apparatus which can be used to connect the hands-free installation to the steering-wheel ring may be in a form such that the mounting apparatus can be clipped onto the steering-wheel ring in comparable fashion to a clip. The mounting apparatus can encompass the steering-wheel ring in an angular range of ≧180°, particularly ≧190°, preferably ≧220°, particularly preferably ≧270°. The mounting apparatus can also encompass the steering-wheel ring essentially completely by virtue of the mounting apparatus comprising a belt, for example, which can embrace the steering-wheel ring. In particular, the mounting apparatus may be in multi-element form in order to achieve comfortable and at the same time secure mounting through the interaction of the individual parts. Particularly preferably, the mounting apparatus is connected to the hands-free installation detachably, for example by means of a clip connection, so that the mounting apparatus can be produced as a separate supplementary component which can be matched, possibly specifically, to particular steering-wheel types and/or different hands-free installation generations.

In a preferred embodiment, the mounting apparatus comprises a holding element, movable in a radial direction relative to the housing, for fixing the hands-free installation to the steering-wheel ring such that it cannot rotate. In particular, the mounting apparatus has a locking device, particularly a screw connection and/or a latch connection, for fixing the mounting apparatus in the mounted state. The locking device can reliably prevent unintentional detachment even under large forces, for example in the event of an accident. By way of example, in the case of a screw connection, the holding element can be pressed against the steering-wheel ring using a comparatively large holding force when tightening the screw. In addition, the mounting apparatus can be used to lock the holding element, which bears against the steering-wheel ring in the mounted state, in various positions. By way of example, the holding element can be moved in a radial direction relative to the steering-wheel ring and can be locked in a plurality of intermediate positions. This allows the hands-free installation to be mounted on the steering-wheel ring using the mounting apparatus regardless of the diameter of the steering-wheel ring.

Particularly preferably, the holding element and/or a side of the housing which is opposite the holding element has an elastic, particularly a rubber-elastic, contact element provided on it which points to the steering-wheel ring in the mounted state. The contact element may be deformed somewhat when the mounting apparatus is mounted, so that the holding element can be locked by the latch apparatus in a position in which a particularly large holding force is exerted on the steering-wheel ring. In addition or as an alternative, the holding element may be prestressed with a detention force by virtue of the holding element being pretensioned by a spring, for example. This allows an additional increase in the holding force in the mounted state. Also, the contact element can compensate for inaccuracies, for example when the curvature of the housing bearing against the steering-wheel ring does not exactly match the curvature of the steering-wheel ring. This allows the hands-free installation to be used for a multiplicity of different steering-wheel ring designs.

### BRIEF DESCRIPTION OF THE DRAWINGS

The invention is explained in more detail below using preferred embodiments with reference to the accompanying drawings, in which:

FIG. 1 shows a schematic front view of an mounted inventive hands-free installation in a first embodiment,

FIG. 2 shows a perspective schematic front view of the hands-free installation from FIG. 1,

FIG. 3 shows a schematic front view of the mounted inventive hands-free installation in a second embodiment,

FIG. 4 shows a perspective schematic front view of the hands-free installation from FIG. 3,

FIG. 5 shows a schematic front view of the mounted inventive hands-free installation in a third embodiment,

FIG. 6 shows a perspective schematic front view of the hands-free installation from FIG. 5,

FIG. 7 shows a schematic front view of the mounted inventive hands-free installation in a fourth embodiment,

FIG. 8 shows a perspective schematic front view of the hands-free installation from FIG. 7,

FIG. 9 shows a schematic front view of the mounted inventive hands-free installation in a fifth embodiment,

FIG. 10 shows a perspective schematic front view of the hands-free installation from FIG. 9,

FIG. 11 shows a schematic front view of the mounted inventive hands-free installation in a sixth embodiment,

FIG. 12 shows a perspective schematic front view of the hands-free installation from FIG. 11,

FIG. 13 shows a schematic front view of the mounted inventive hands-free installation in a seventh embodiment,

FIG. 14 shows a perspective schematic front view of the hands-free installation from FIG. 13, and

FIG. 15 shows a schematic front view of a mounting apparatus connected to a hands-free installation.

### DETAILED DESCRIPTION OF PREFERRED EMBODIMENTS

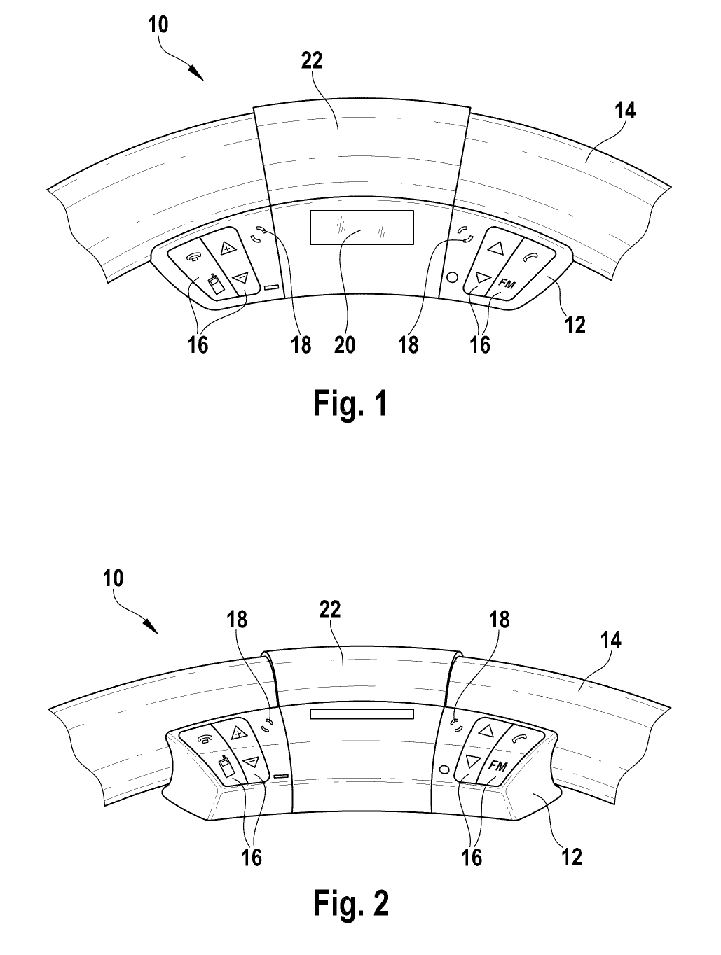

In an inventive hands-free installation 10 as shown in FIG. 1, a housing 12 matches a steering-wheel ring 14 on a motor vehicle steering wheel such that the radially outwardly pointing contour of the housing 12 follows the curvature of the radially inwardly pointing contour of the steering-wheel ring 14. The front of the hands-free installation 10 is provided with a plurality of operator control elements 16 in the form of keys which can be used to perform the functions of the hands-free installation 10. In addition, the front is provided with openings 18, behind which it is possible to arrange a microphone and/or a loudspeaker. To be able to read off the called or calling telephone number and/or subscriber name, the housing 12 comprises a display 20 provided in it. In the exemplary embodiment shown, the display 20 is additionally protected by a transparent mounting apparatus 22 which has been used to securely clip the housing 12 of the hands-free installation 10 onto the steering-wheel ring 14. The housing 12 bears against the steering-wheel ring 14 essentially without any gap, since the housing 12 not only follows the curvature of the steering-wheel ring 14 but is also contoured in the circumferential direction of the steering-wheel ring 14 such that the housing 12 bears against the steering-wheel ring 14 (FIG. 2).

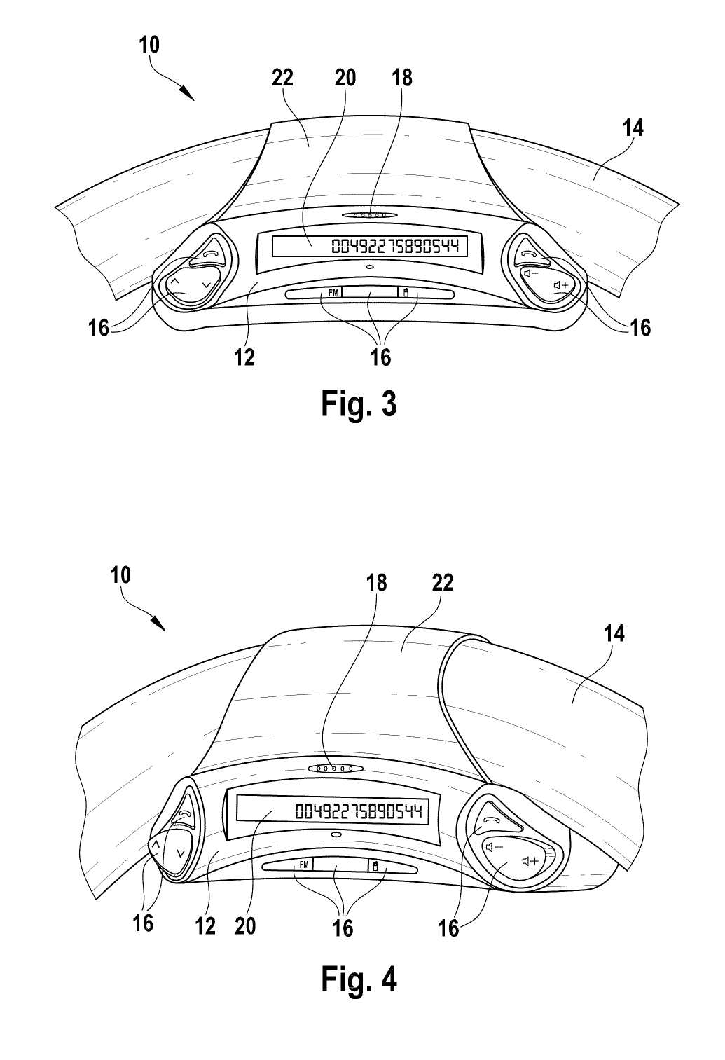

In the embodiment of the hands-free installation 10 which is shown in FIG. 3, the mounting apparatus 22 is integrally connected to the housing 12. The mounting apparatus 22 encompasses the steering-wheel ring 14 in the circumferential direction in an angular range of significantly more than 190° (FIG. 4).

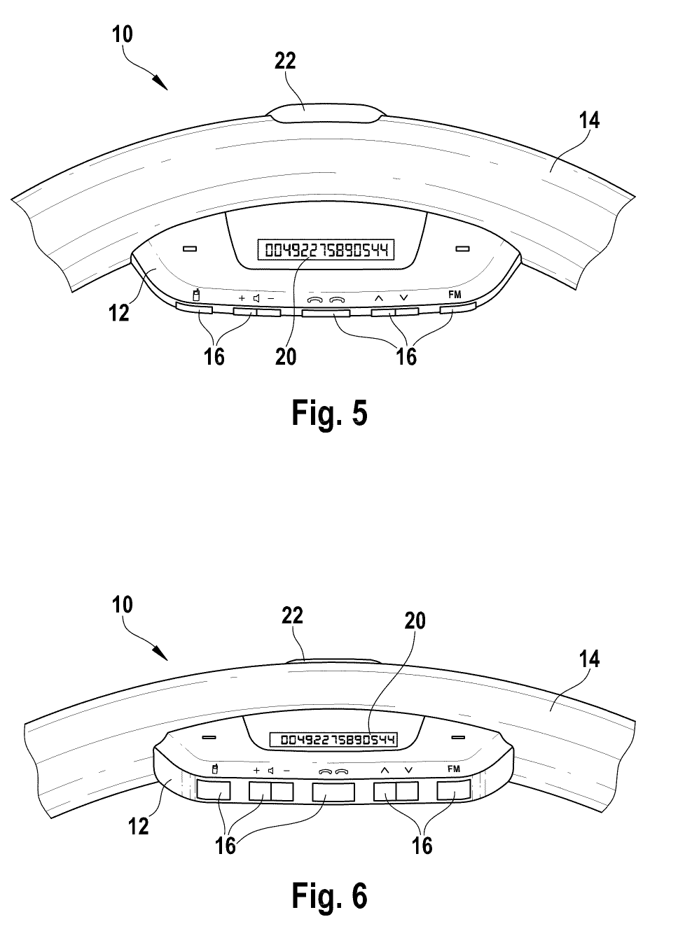

The hands-free installation 10 shown in FIG. 5 has a mounting apparatus 22 which partially encompasses the steering-wheel ring 14 from behind. In the exemplary embodiment shown, the operator control elements 16 are arranged on the side (FIG. 6), so that when the operator control elements 16 are operated the housing 12 of the hands-free installation 10 is additionally pushed against the steering-wheel ring 14, which prevents the housing 12 from slipping on the steering-wheel ring 14.

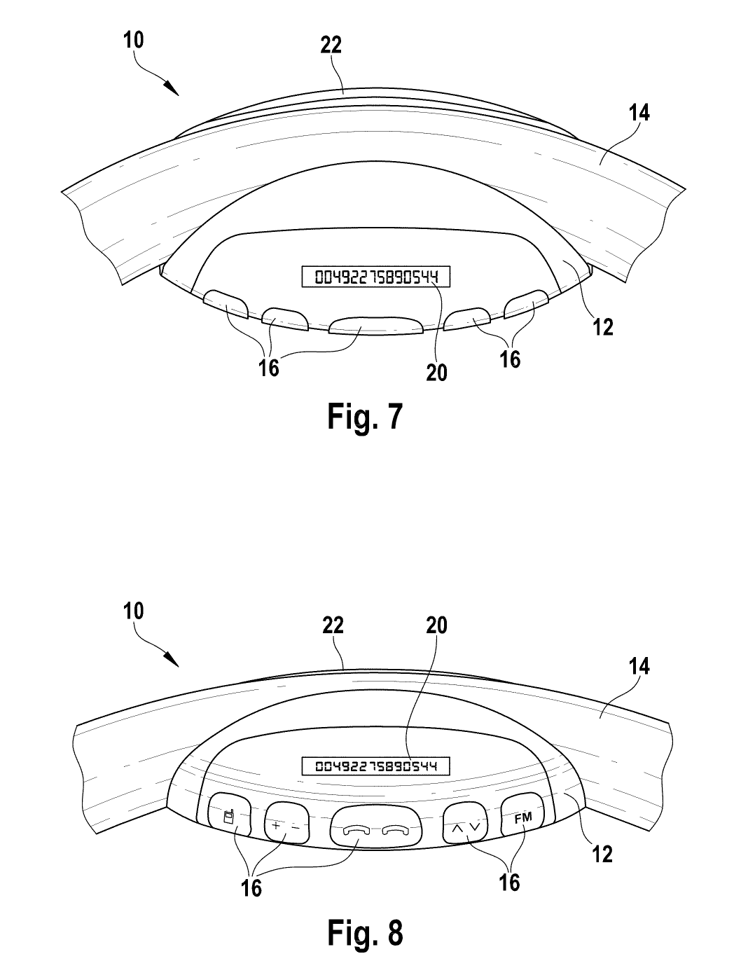

In comparison with the hands-free installation 10 shown in FIG. 5 and FIG. 6, the hands-free installation shown in FIG. 7 and FIG. 8 comprises a mounting apparatus 22 which is of much broader design and whose contour matches particularly the curvature of the steering-wheel ring 14. On account of the relatively large contact area between the mounting apparatus 22 or housing 12 and the steering-wheel ring 14, a correspondingly high level of friction and hence an increased holding force arise which prevent the hands-free installation 10 from slipping on the steering-wheel ring 14.

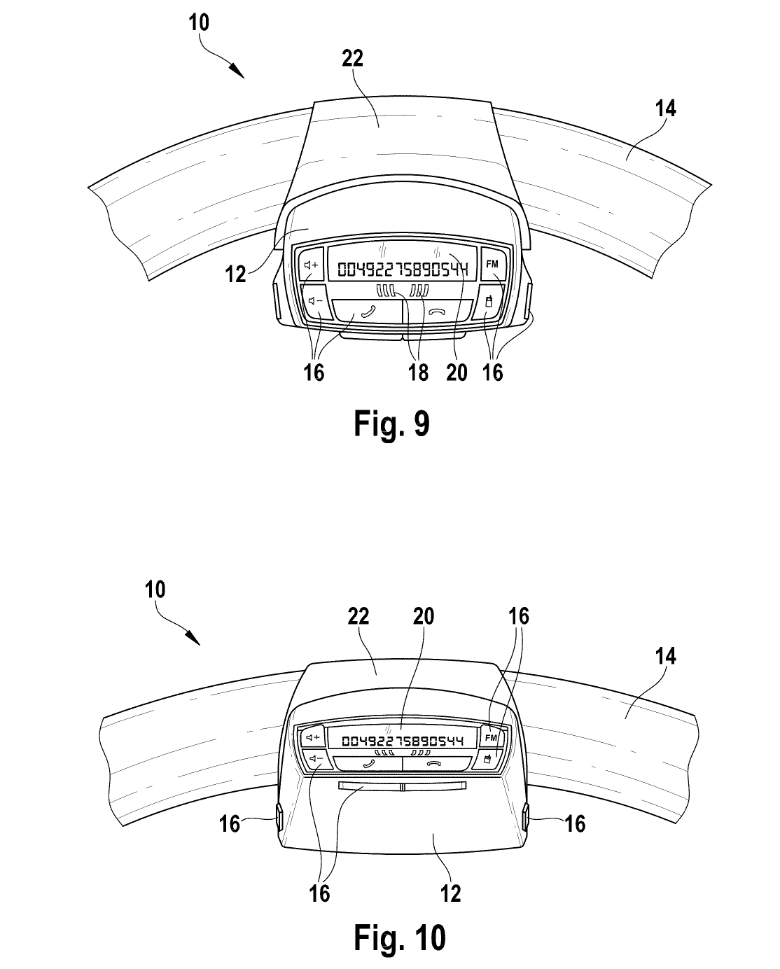

In the case of the hands-free installation 10 shown in FIG. 9, the display 20 has more than one line for presenting information. By way of example, it is possible to show both a telephone number and an associated name. The data required for this can be obtained by the hands-free installation 10 from a mobile telephone associated with a hands-free installation 10 using a communication device (not shown), in particular wirelessly, for example by means of Bluetooth. In addition, in principle, it is possible for the operator control elements 16 to be provided either on the front of the housing 12 (FIG. 9) or on the various side faces of the housing 12 (FIG. 10).

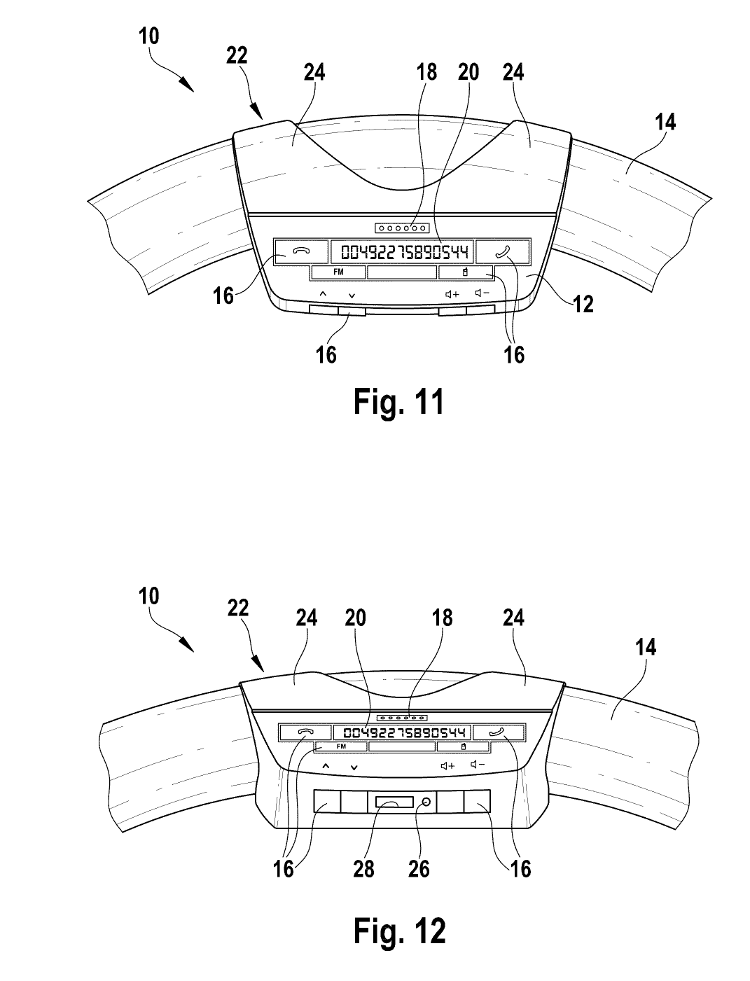

In the exemplary embodiment of the hands-free installation 10 which is shown in FIG. 11, the mounting apparatus 22 comprises two arms 24 at a distance from one another which respectively encompass the steering-wheel ring 14 at least partially. This achieves stable mounting with relatively little use of materials. In addition, it is possible to connect an external power source using an electrical connection 26, for example in order to charge storage batteries arranged in the housing 12 for supplying power to the communication device (FIG. 12). In particular, it is possible to use a USB port 28 to connect a USB stick, for example, in order to play music stored on the USB stick via the hands-free installation 10, for example.

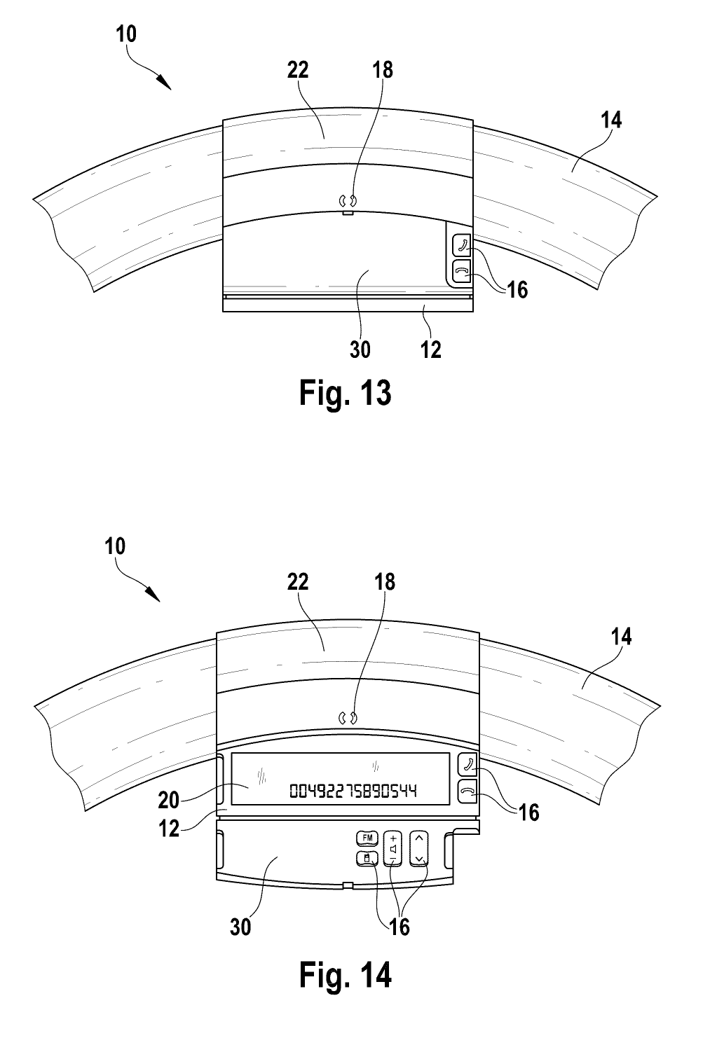

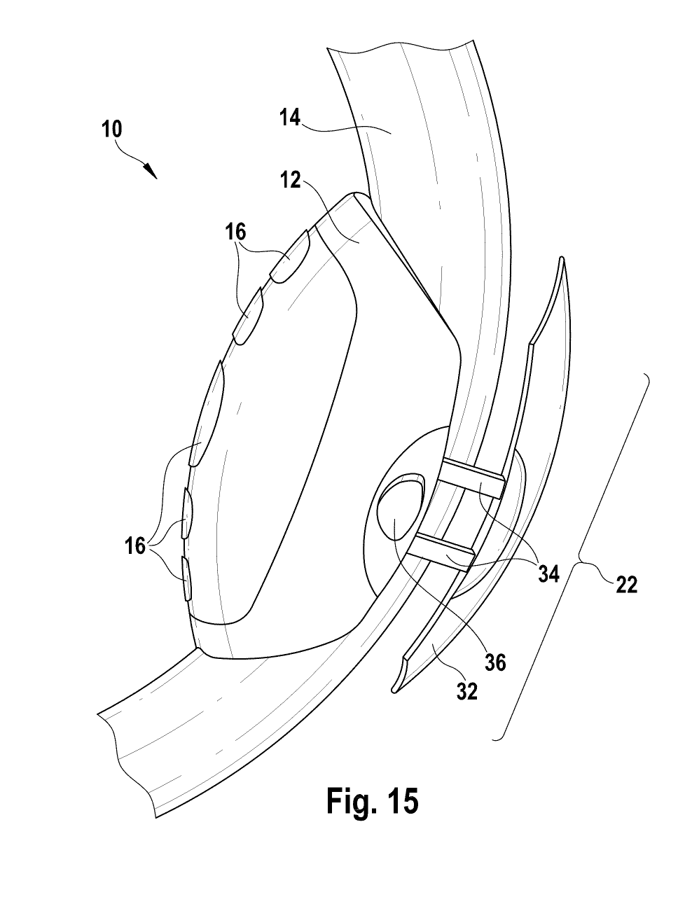

The hands-free installation 10 shown in FIG. 13 comprises a display 20 closed up by means of a lid 30. In the folded-back state (FIG. 14), the usable space on the hands-free installation is significantly increased. When the hands-free installation 10 or at least the display 20 is not needed, the space requirement for the hands-free installation 10 is relatively small. Only when needed is it possible to provide a particularly large amount of space, for example in order to provide a particularly large number of operator control elements 16. By way of example, the lid 30 can contain additional operator control elements 16 in order to operate a CD player, a car radio etc. or a plurality of letter keys, for example for writing SMSs.

The mounting apparatus 22 can comprise a holding element 32 which can be locked to the housing 12 of the hands-free installation 10 using latch elements 34. To release the lock, a button 36 is provided which the driver can push to remove the hands-free installation 10 from the steering-wheel ring 14. To mount the hands-free installation 10 on the steering-wheel ring 14, the driver can push the holding element 32 onto the steering-wheel ring 14, with the latch elements 34 in this case being able to pass through a plurality of latch positions. When the latch elements 34 are at the maximum possible depth of insertion, the hands-free installation 10 is connected to the steering-wheel ring 14 both by means of matching shapes and with frictional engagement.

1. A hands-free installation for a mobile telephone, comprising:
a housing;
an electrical communication device, located in the housing, for communicating with the mobile telephone; and
a microphone connected to the communication device; wherein:
the housing comprises a mounting apparatus for detachably connecting the hands-free installation to a steering-wheel ring of a motor vehicle steering wheel, and
the housing is adapted to fit a contour of the steering-wheel ring.

2. The hands-free installation according to claim 1, wherein the housing is adapted to fit a radially inwardly pointing contour of the steering-wheel ring.

3. The hands-free installation according to claim 1, wherein the mounting apparatus comprises a holding element, which is movable in a radial direction relative to the housing, for fixing the hands-free installation to the steering-wheel ring such that the hands-free installation cannot rotate about the steering-wheel ring.

4. The hands-free installation according to claim 3, wherein the holding element and/or a side of the hands-free installation which is opposite the holding element includes an elastic contact element arranged on it.

5. The hands-free installation according to claim 1, wherein the mounting apparatus includes a locking device for fixing the mounting apparatus to the steering-wheel ring in a mounted state.

6. The hands-free installation according to claim 1, wherein at least one loudspeaker is connected to the communication device and the housing comprises one or more loudspeaker outputs that point to a driver when the hands-free installation is in a mounted state on the steering-wheel ring.

7. The hands-free installation according to claim 1, wherein the mounting apparatus encompasses the steering-wheel ring in an angular range of ≧180° when the hands-free installation is in a mounted state on the steering-wheel ring.

8. The hands-free installation according to claim 1, wherein the communication device communicates with the mobile telephone wirelessly.

9. The hands-free installation according to claim 1, wherein the communication device is adapted to communicate with an external sound installation which comprises a loudspeaker so as to output sounds.

10. The hands-free installation according to claim 1, further comprises a fold-back display for presenting information.

11. The hands-free installation according to claim 4, wherein the elastic contact element is made of rubber.

12. The hands-free installation according to claim 1, wherein the mounting apparatus encompasses the steering-wheel ring in an angular range of ≧190° when the hands-free installation is in a mounted state on the steering-wheel ring.

13. The hands-free installation according to claim 1, wherein the mounting apparatus encompasses the steering-wheel ring in an angular range of ≧220° when the hands-free installation is in a mounted state on the steering-wheel ring.

14. The hands-free installation according to claim 1, wherein the mounting apparatus encompasses the steering-wheel ring in an angular range of ≧270° when the hands-free installation is in a mounted state on the steering-wheel ring.

15. The hands-free installation according to claim 8, wherein the communication device communicates with the mobile telephone wirelessly by radio.

16. The hands-free installation according to claim 8, wherein the communication device communicates with the mobile telephone wirelessly by means of BLUETOOTH technology.

17. The hands-free installation according to claim 9, wherein the external sound installation is a car radio and/or a CD player.

18. The hands-free installation according to claim 9, wherein the communication device communicates with the external sound installation using A2DP.

19. The hands-free installation according to claim 10, wherein the fold-back display communicates with the mobile telephone and/or a position finding system.

20. The hands-free installation according to claim 10, wherein the fold-back display is a color-adjustable backlit full display for presenting at least 14 characters per line.
